(19) United States
(12) Patent Application Publication
(10) Pub. No.: US 2018/0244921 A1
(43) Pub. Date: Aug. 30, 2018

(54) SELF-SENSING PIEZORESISTIVE HOT MIX ASPHALT

(71) Applicant: University of Louisiana at Lafayette, Lafayette, LA (US)

(72) Inventors: Mohammad Jamal Khattak, Lafayette, LA (US); Ahmed Khattab, Lafayette, LA (US); Mohammad Madani, Lafayette, LA (US); Hashim R. Rizvi, Glassboro, NJ (US)

(21) Appl. No.: 15/906,194

(22) Filed: Feb. 27, 2018

Related U.S. Application Data
(60) Provisional application No. 62/463,792, filed on Feb. 27, 2017.

(51) Int. Cl. C08L 95/00; E01C 7/26; E01C 7/22; E01C 19/02

(52) U.S. Cl. CPC C08L 95/00; E01C 7/262; C08L 2555/52; E01C 19/02; C08L 2555/50; E01C 7/22

(57) ABSTRACT

Nano-reinforced materials hold the potential to redefine traditional materials both in terms of performance and potential applications. Dispersing carbon nanofibers (“CNF”) in Hot Mix Asphalt mixtures creates a piezoresistive effect and classifies the new mixture as a “smart material.” The current invention uses the electromechanical capabilities of carbon fibers to sense its own strain by way of electrical resistivity to develop a Self-sensing Piezoresistive Hot Mix Asphalt.

### CROSS REFERENCE TO RELATED APPLICATIONS

This application claims priority to U.S. Provisional Application No. 62/463,792, SELF-SENSING PIEZORESISTIVE HOTMIX ASPHALT, filed on Feb. 27, 2017.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Self-sensing Piezoresistive Hot Mix Asphalt, which may be embodied in various forms. It is to be understood that in some instances, various aspects of the invention may be shown exaggerated or enlarged to facilitate an understanding of the invention. Therefore, the drawings may not be to scale.

FIG. 1 (a) is a graph that depicts % change in resistivity (Δρ).

FIG. 1 (b) is a graph that depicts % change in resistance (ΔR).

FIG. 1 (c) is a graph that depicts % change in voltage (ΔV).

FIG. 1 (d) is a graph that depicts resistivity (ρ), as a function of time and compressive stress.

FIG. 2 depicts the actual copper wire and schematic of wire and plate electrodes embedment in sample

FIG. 3 (a) is a graph that depicts voltage response of plated electrodes.

FIG. 3 (b) is a graph that depicts voltage response of wire electrodes.

FIG. 3 (c) is a graph that depicts voltage response of signal of plate electrode samples.

FIG. 3 (d) is a graph that depicts voltage response of signal of wire electrode samples.

FIG. 4 depicts a typical compressive stress and change in resistance as a function of time for CNF (LHT)-modified PAC30 and AC5 HMA under ramp loading.

FIG. 5 (a) is a graph of the 5.3% CNF-LHT PAC-30 resistivity response at 25 Hz.

FIG. 5 (b) is a graph of the 5.3% CNF-LHT PAC-30 resistivity response at 10 Hz.

FIG. 5 (c) is a graph of the 8.5% CNF-XTPS PAC-30 resistivity response at 25 Hz.

FIG. 5 (d) is a graph of the 8.5% CNF-XTPS PAC-30 resistivity response at 10 Hz.

FIG. 6 (a) depicts a graph of 5.3% CNF-LHT PAC30 resistivity response with compressive strain at 1 Hz.

FIG. 6 (b) depicts a graph of 8.5% CNF-XTPS PAC30 resistivity response with compressive strain at 1 Hz.

FIG. 7 (a) relative to compressive stress

FIG. 7 (b) is a graph of the Piezoresistive response of 5.3% CNF-LHT PAC30 HMA mixture under repeated creep loading, relative to compressive strain.

FIG. 8 (a) depicts the Piezoresistive response of 8.5% CNF-XTPS PAC30 sample under repeated creep loading, relative to compressive stress with % Δρ.

FIG. 8 (b) depicts the Piezoresistive response of 8.5% CNF-XTPS PAC30 sample under repeated creep loading, relative to compressive strain with % Δρ.

FIG. 9 (a) is a graph that depicts the Piezoresistive response of 5.3% CNF-LHT PAC30 mixture under haversine loading with Compressive Stress 20° C.

FIG. 9 (b) is a graph that depicts the Piezoresistive response of 5.3% CNF-LHT PAC30 mixture under haversine loading with compressive strain at 20° C.

FIG. 10 (a) is a graph that depicts the Piezoresistive response of 5.3% CNF-LHT PAC30 mixture under haversine loading with compressive stress at 40° C.

FIG. 10 (b) is a graph that depicts the Piezoresistive response of 5.3% CNF-LHT PAC30 mixture under haversine loading with compressive stress at 60° C.

FIG. 11 (a) is a graph that depicts the Piezoresistive response of 5.3% CNF-LHT PAC30 mixture under haversine loading with compressive strain at 40° C.

FIG. 11 (b) is a graph that depicts the Piezoresistive response of 5.3% CNF-LHT PAC30 mixture under haversine loading with compressive strain at 60° C.

FIG. 12 (a) is a graph of the resistivity behavior of 5.3% CNF-LHT PAC30 under constant haversine stress with number of cycles and compressive plastic strain RLPD at 20° C. with plastic strain and resistivity.

FIG. 12 (b) is a graph of the resistivity behavior of 5.3% CNF-LHT PAC30 under constant haversine stress with number of cycles and compressive plastic strain RLPD at 20° C. with rate of plastic strain and resistivity.

FIG. 13 (a) is a graph of the resistivity of behavior of 5.3% CNF-LHT PAC30 under constant haversine stress with number of cycles and compressive plastic strain RLPD at 40° C. with plastic strain and resistivity.

FIG. 13 (b) FIG. 13 (a) is a graph of the resistivity of behavior of 5.3% CNF-LHT PAC30 under constant haversine stress with number of cycles and compressive plastic strain RLPD at 40° C. with rate of plastic strain and resistivity.

FIG. 14 (a) is a graph of the resistivity behavior of 5.3% CNF-LHT PAC30 under constant haversine stress with number of cycles and compressive plastic strain RLPD at 60° C. with plastic strain and resistivity.

FIG. 14 (b) is a graph of the resistivity behavior of 5.3% CNF-LHT PAC30 under constant haversine stress with number of cycles and compressive plastic strain RLPD at 60° C. with rate of plastic strain and resistivity.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

Over the past few decades the demand for smart, high performance, resilient and sustainable structural systems has increased exponentially. One way of achieving such multifunctional structural systems is to develop construction materials that possess some or all the aforementioned characteristics. High performance and sustainability can be attained through enhancing the ductility and durability properties of structural materials under extreme loadings and environmental conditions. These smart characteristics are accomplished by modifying the materials using nano-materials (carbon nanofibers, “CNF,” or nanotubes, “CNT”) that could enhance the self-sensing abilities of materials by incorporating piezoresistive effects. Such materials can sufficiently change their resistivity with the application of load to act as sensors.

A “smart structures” or “intelligent structures,” are built with a combination of smart and conventional materials and contain intelligent systems that can gather information, perform task, and sense variation in material conditions, adapting accordingly. High-performance structures, such as skyscrapers, long-span bridges, and dams are the most probable candidates for the application of intelligent structures.

Hot Mix Asphalt (“HMA”) is commonly used for pavement. It is a combination of approximately 95% aggregate (e.g., stone, sand, or gravel) bound together by an asphalt binder. HMA pavement can often experience extreme loads that vary greatly ranging from a bicycle or foot traffic to a semi-truck carrying hundreds of tons. HMA pavement is also exposed to the elements and must be able to maintain structural integrity in, for example, blistering heat and freezing rain. However, HMA is prone to cracking and failure due to continued strain and stress. Therefore, it would be advantageous for HMA to be able to sense and react to the varying levels of strain. Applications of such a “smart” material include: thermal electric de-icing of airport runways or highways, cathodic protection of concrete bridge decks, pavement damage sensing, and truck weigh-in-motions.

Piezoresistive HMA mixtures are developed by doping the HMA mixtures with conductive materials. Such HMA mixtures exhibit a change in electrical resistivity due to the change in stress or strain response of the material at room temperature. Piezoresistive response would only be optimum in a certain range of compressive stress, after which this effect will decrease. The piezoresistive response of material can be segmented in three parts: initial part of rapid decrease in response, stabilized part of constant response, and final part of rapid increase in response. This phenomenon illustrates that change in resistivity of a material decreases initially and then becomes stabilized until damage is experienced.

Nano-reinforced materials hold the potential to redefine traditional materials both in terms of performance and potential applications. Dispersing carbon nanofibers (“CNF”) in HMA mixtures creates a piezoresistive effect and classifies the new mixture as a “smart material.” The current invention uses the electromechanical capabilities of carbon fibers to sense its own strain by way of electrical resistivity to develop a Self-sensing Piezoresistive Hot Mix Asphalt.

Self-sensing Piezoresistive Hot Mix Asphalt comprises an asphalt binder, an aggregate, and a conductive filler. In one embodiment, viscosity graded asphalt AC5 (PG52-22) is used as the asphalt binder. In other embodiments, a Polymer modified PAC30 (PG70-28) is uses as the asphalt binder. However, any suitable asphalt binder as known in the art may be used. In one embodiment, angular limestone is used as the aggregate. However, any suitable aggregate as known in the art may be used. In one or more embodiments, Vapor-grown CNF PR-24XT-XTPS (“XTPS”) is used as the conductive filler. In other embodiments, CNF PR-24XT-LHT (“Polygraf III” or “LHT”) is used as the conductive filler. However, any suitable HMA modifier may be used so long as the performance to cost ratio is relativity high and the HMA modifier is capable of suitable interfacial bonding with the other materials within the HMA.

In the embodiments described above, each of the suggested CNF modifiers has a diameter of 60-150 nm, length of 30-100 μm, average tensile modulus of 600 GPa and average tensile strength of 7 GPa. Further, each has an Iron and Polyaromatic Hydrocarbons content of <1400 ppm and <1 mg PAH/g, respectively.

The conductive HMA has two phases of application of conductive fillers: (1) CNF in the binder and (2) CNF in the aggregates. The thin film coating of aggregate is known as structured binder, whereas the rest of the binder is known as free binder.

In order to create the conductive HMA, the CNF must be adequately blended in the asphalt binder. The current application presents two inventive methods for accomplishing this task: Wet Mixing Process and Dry Mixing Process.

In one embodiment, a Wet Mixing Process is used to combine the CNF and HMA. First, a partial amount of CNF is homogenously dispersed in cut back solvent by sonication and high shear mixing. In one embodiment, the percentage of CNF is 1.5% by weight of binder. The CNF-solvent mixtures is then mixed with the asphalt binder at set mixing temperatures—for example, 150° C. for AC5 and 175° C. for PAC30—using a shear mixer, until all the solvent has evaporated. The remaining amount of CNF (depending on the total dosage to be mixed with HMA) is then homogenously dispersed into the solvent using sonication and high shear mixing. The solvent is then allowed to evaporate at room temperature followed by oven heating to obtain fully dried and dispersed CNF. Finally, the aggregates, CNF modified asphalt binder, and oven-dried CNF is heated in an oven at the mixing temperature. All the components are then mixed thoroughly by using, for example, a bench mixer. Thus, a homogeneous dispersion of CNF is achieved through this rigorously developed mixing method.

In other embodiments, a Dry Mixing Process is used. These embodiments are similar to the Wet Mixing Process, except that dry CNF, as obtained from the manufacturer, is added in the asphalt binder first and then into the HMA mixture. Small dosages of dry CNF are mixed in the asphalt binder using a shear mixture at a set temperature. In one embodiment, the dosage percentage of CNF is about 0.3% by weight of binder and the set temperature is 135° C. The remaining CNF is mixed with the aggregates. Finally, the CNF modified asphalt binder and aggregates mixed with remaining amount of CNF are heated in an oven at the mixing temperature. In one embodiment, this mixing is performed using a bench mixer.

The result of either embodiments is an inventive HMA mixture dosed with CNF. This mixture, as demonstrated in Example 1 below, has piezoresistive capabilities allowing it to sense its own strain and react accordingly.

### Example 1

A Superpave mixture design procedure was adopted to conduct the mixture design. The mix design yielded 5.7% optimum asphalt content. The aggregate gradation used for HMA mixture is shown in Table 1.

TABLE 1
Aggregate gradation used for the study

| | Sieve (mm) | | | | | | | | |
|---|---|---|---|---|---|---|---|---|---|
| | | | | | | No. | No. | No. | No. |
| | 12.5 | 9.5 | No. 4 | No. 8 | No. 16 | 30 | 50 | 100 | 200 |
| Passing | 100 | 95 | 60 | 42 | 28 | 18 | 11 | 5 | 2 |
| (%) | | | | | | | | | |

Piezoresistive response of CNF modified HMA mixtures under various types of compression loading were determined using 150 mm tall and 100 mm diameter cylindrical samples. The loose HMA mixture heated to a compaction temperature and poured in a steel mold in five layers. Each layer consisted of 540 gm of loose HMA mix followed by 5 gyrations of compaction before electrode placement. After all of the four electrodes were embedded, the sample was placed back in the oven at the mixing temperature for 45 minutes. Then, 185 gyrations were applied to obtain a fully compacted sample ready for piezoelectric testing under compression loading. The above procedure yielded uniform distance, about 30±2 mm, between the electrode and air void content of 4±0.5%.

A current source meter was used for constant current supply, a picometer/voltage source was used as Amp-meter and a multimeter was utilized to determine the voltage output. Voltage response was directly measured by the material testing system (“MTS”) data acquisition system. Copper wires and copper plates were embedded in the HMA samples as electrodes. The resistivity (ρ, Ω-m) and resistance (R, Ω) were determined using the following sets of equations.

$$\begin{matrix}ρ = 2 π sR & ( Eq . 1 ) \\ R = \frac{V}{I} & ( Eq . 2 )\end{matrix}$$

### Where,

ρ=Resistivity of the sample in Ω-m
s=Distance between the electrodes, meters
R=Resistance of the sample between two outer electrodes, Ω
V=Voltage measured between two inner electrodes, Volts
I=Constant current, Amp.

The following parameters were calculated to evaluate the piezoresistive response of the HMA mixtures.

$$\begin{matrix}\% Change in Resistivity ( Δ ρ ) = \vert ( \frac{{ρ}_{0} - ρ}{{ρ}_{0}} ) \vert \times 100 & ( Eq . 3 ) \\ \% Change in Resistance ( Δ R ) = \vert ( \frac{{R}_{0} - R}{{R}_{0}} ) \vert \times 100 & ( Eq . 4 ) \\ \% Change in Voltage ( Δ V ) = \vert ( \frac{{V}_{0} - V}{{V}_{0}} ) \vert \times 100 & ( Eq . 5 )\end{matrix}$$

Where, Δρ, ΔR and ΔV are percentage change in resistivity, resistance and voltage due to applied loads, respectively and ρ₀, R₀, and V₀ are initial resistivity, resistance and voltage values just before the application of load, respectively.

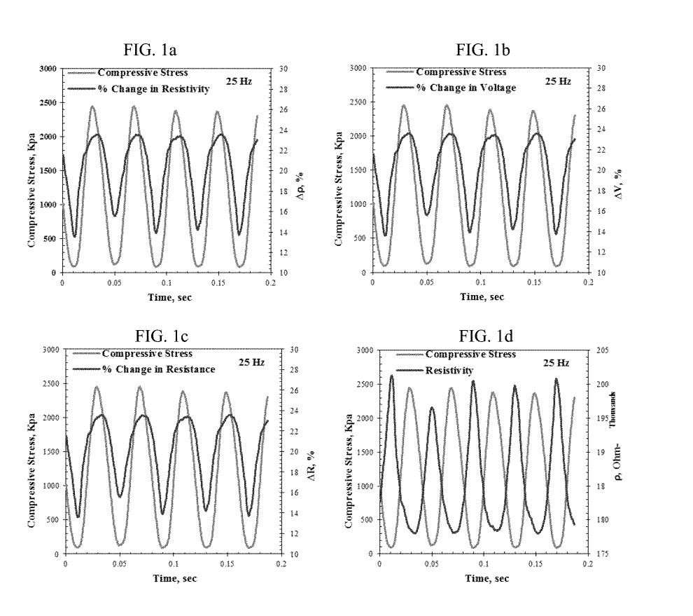

FIG. 1 (a, b, c) shows typical behaviors of the above three piezoresistive response parameters under sinusoidal loading at a frequency of 25 Hz. According to FIG. 1 (a, b, c), all the response parameters follow the same trend. Therefore, any of these three parameters could be selected to evaluate the piezoresistive effect of a material. FIG. 1 (a, b, c) shows that the piezoresistive response of samples follows the loading cycles in direct manner. This means that the percentage change in V, R, ρ increases or decreases with increase or decrease in applied stress, respectively. On the other hand, FIG. 1 (d) shows that ρ follows the stress signal in a reverse manner. This is mainly because of the proximity effect of the electrodes. As the stress level increases the electrodes come closer to each other and, therefore, the p of mixture decreases. This trend was observed in all the samples tested for this example.

A four-probe method with improvisation was utilized in this example to measure the response of CNF modified HMA mixtures. The electrodes were embedded in the samples—instead of pasting them on the surface—to achieve a better contact. CNF are dispersed throughout the entire mixture; therefore, measuring the response only at the surface of the sample is not functional. Also, electrical properties can vary significantly with humidity variation in the environment. Such variation could be minimized with embedded electrodes.

Two methods to embed the electrode in the HMA sample were used in this Example: after compaction and during compaction. Embedding electrodes in a compacted sample was difficult and cumbersome, whereas it was relatively easy to embed the electrodes during compaction. Additionally, methods for embedding electrodes in the compacted sample (e.g., hammering or drilling copper wire or nails into the sample) were inadequate and caused the asphalt binder to peel off of the aggregate, exposing the uncoated aggregates. Because aggregates are insulators, the conductivity was reduced. Embedding the electrodes just after compaction to take advantage of the softness of the mixture also produced inadequate results. The fragility of the sample caused de-shaping, excessive damage, and loose contact of the electrodes.

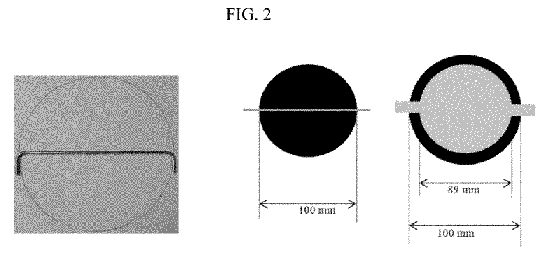

FIG. 2 depicts the embedment method used in this Example: Copper wires and copper plates were embedded in the sample during the compaction process. The samples were compacted in 5 successive layers and each layer was compacted to 5 gyrations. After each layer, the copper wire was embedded. FIG. 2 shows the schematic and copper electrodes embedded in sample. In this Example, the surface area of the copper wire, 2 mm in diameter, was used in order to have a relatively low surface area of copper wire compared to the sample. This reduced the electrical signal disturbance while measuring the response of the mixture under cyclic loading. Additionally, the wire avoided excessive bending that occurred when using copper plates.

HMA specimens with embedded electrodes were subjected to dynamic frequency sweep test under compression loading. Testing was performed using a closed-loop servo-hydraulic machine, manufactured by Material Testing System (“MTS”). The mixtures were tested at frequencies of 25, 10, 5, and 1 Hz under a stress control mode at 20° C. Compression loading was applied, and the deformation was measured using four surface mounted miniatures linear variable differential transformers (“LVDT”), placed vertically and 90 degrees apart. The gauge length for LVDT was kept at 57.2 mm.

The following test were conducted on the samples to determine various properties and loading characteristics. (1) A repeated compression creep loading test was conducted at 20° C. by applying a sustained compressive loading for 150 second and unloading of 150 second. The load, deformation and piezoelectric response were measured as stated above. (2) A continuous compressive ramp loading was applied at a rate of 0.51 mm/min at room temperature. The test was stopped after a complete failure of the sample occurred. The deformations were measured and recorded as above. (3) A continuous haversine loading was applied with a 0.1 second loading and a 0.5 second rest period to determine the repeated load permanent deformation (“RLPD”). This test was performed within the viscoelastic range of the mixture, i.e.—80 to 100 microns, and using the controlled temperature chamber at test temperatures of 20, 40 and 60° C.

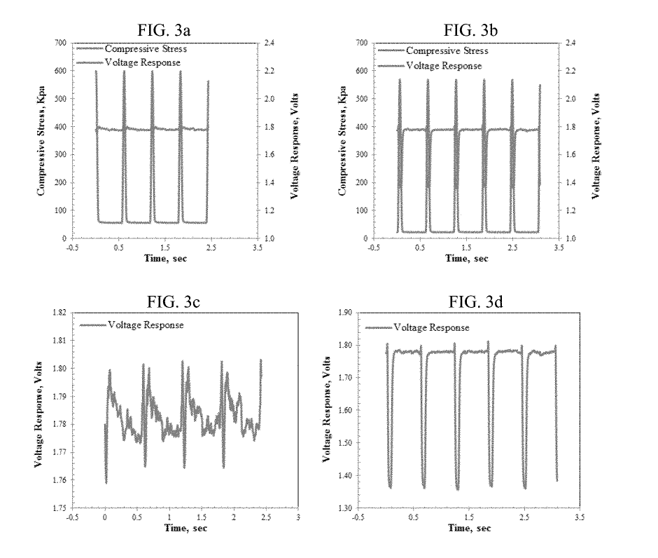

FIG. 3 (a, b), shows the voltage signal obtained from loaded samples having different electrode types: copper wire and copper plate. It can be observed that the voltage signal due to load is significantly higher in magnitude and smooth for the samples having wires as compare to the ones embedded with plate electrodes. The wire electrode sample showed consistent response of approximately 0.4 volts, while the plate electrode sample showed approximately 0.02 volts. It should also be observed that noise-to-signal ratio of plate electrode is significantly higher than the wire electrode samples. FIG. 3 (c, d), illustrates the signal of plate electrode and wire electrode samples, respectively. It can be observed that noise-to-signal ratio in plate electrode sample shown in FIG. 3 (c) is significantly higher than the wire electrode samples as in FIG. 3 (d). The possible reason of this is variation of electrical current flow in plate samples: plates do not allow aggregates to pass through during compaction which results in de-shaping and amplified stress in certain zones of the plate. These amplified stress zones let excessive flow of current through that zone. This phenomenon creates an imbalance in the flow of current within the surface area of the electrode. Therefore, voltage signal which is directly recorded using automatic data collection during loading, showed a disturbed signal. The wire electrode sample showed a smooth and clean voltage signal. Therefore, wire electrode samples were used throughout the Example.

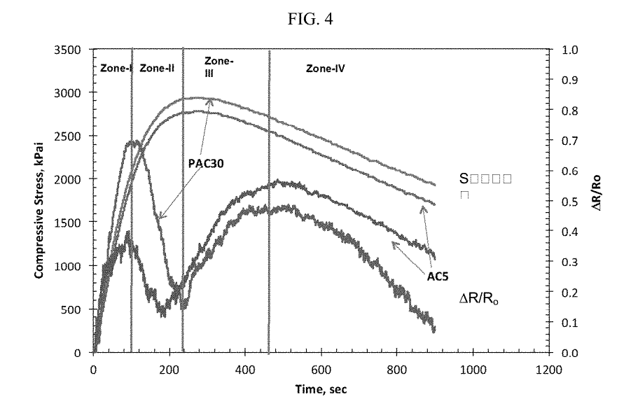

FIG. 4 shows the stress and fractional change in resistance as a function of time of two types of conductive HMA constructed using PAC30 and AC5 with 6.5% LHT CNF at 20° C. A strength test was conducted at a rate of 51 mm/min and the electrical signal was recorded during the duration of test. The data in FIG. 4 can be divided in four zones: Zone-I: initial increase in ΔR/R, Zone-II: decrease in ΔR/R, Zone-III: secondary increase in ΔR/R, and Zone-IV: final decrease in ΔR/R. In order to explain the aforementioned zones, three types of phenomena should be considered (1) proximity effect, (2) nano and micro crack generation, and (3) dislocation of conductive path due to movement of aggregates. It can be observed that in the Zone-I ΔR/R follows stress increase, which is due to proximity effect. Zone-II exhibits decrease in ΔR/R, which is due to micro/macro crack generation with stress increase. It was observed that both samples showed this behavior at a strain level of about 3100 microns. Micro/macro-cracks decrease the change in resistance because of a loos of the conductive network. At approximately the maximum strength level the proximity effect overcomes the micro/macro-crack effect and ΔR/R starts increase again as in Zone-III. The dislocation of conductive path due to high shear movement of the aggregates also played its role in Zone-II which incremented the effect of cracks. However, the sample started to bulge rapidly, which augmented the proximity effect in Zone-III and it continued until the occurrence of fully developed macro cracks at the final failure and breakage point. At this stage the conducted path started to break vigorously and the sample entered Zone-IV, in which the sample experienced a constant decrease in ΔR/R.

The data in FIG. 4 also indicates that CNF modified PAC30 experienced more change in resistance as compare to CNF modified AC5 HMA. This difference is due to conductivity of the sample. CNF modified PAC30 is more conductive than the CNF modified AC5 sample; higher conductive mixtures exhibit a higher response to loading. The PAC 30 sample also exhibited a smoother response compared to the AC5 sample because PAC30 tends to produce a more rigid material. This Example also indicated the dislocation effect in the conductive paths is less for PAC30 as compare to AC5 modified with CNF.

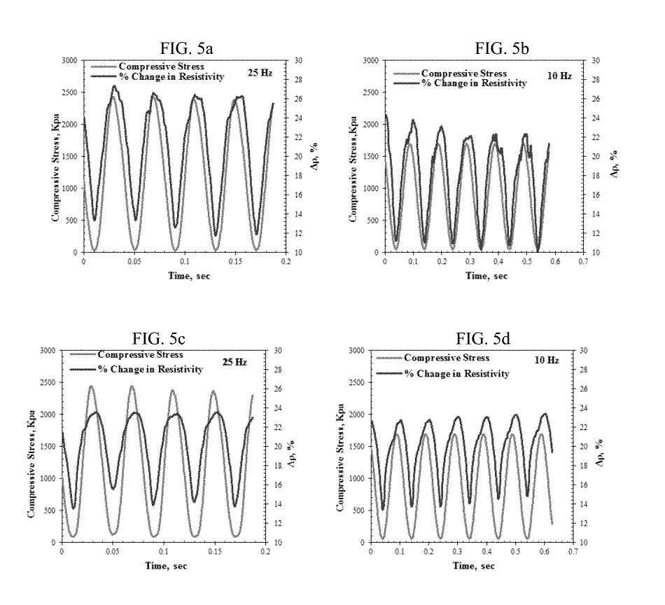

FIG. 5 depicts the resistivity response of HMA mixtures modified with two different types of CNF at 25 Hz and 10 Hz at 20° C. FIG. 5 (a, b) shows the response of 5.3% CNF-LHT modified HMA and FIG. 5 (c, d) illustrates the response of 8.5% CNF-XTPS modified HMA. The differences in CNF dosages correlate to the reduced conductive characteristics of CNF-XTPS. The lowest CNF dosage at which the sample began to produce a reasonable response under loading was found to be 8.5% and 5.3% for CNF-XTPS and CNF-LHT modified HMA mixtures, respectively.

The initial resistivity measurements of CNF-XTPS and CNF-LHT modified mixture were found to be 131.5 Ω-m and 165.7 Ω-m, respectively. The results are likely due to the fact that the percentage of fiber in XTPS is 50% more than that of the LHT.

The average responses of LHT and XTPS samples at 25 Hz were 22 Ω-m and 11 Ω-m, respectively. On average, the difference in the maximum and minimum value of percentage response of CNF-LHT and CNF-XTPS modified mixtures was 14% and 8%, respectively. This indicates that CNF-LHT has better response abilities under cyclic loading as compare to CNF-XTPS. Furthermore, the signal is relatively clear for CNF-LHT, with only few abruptions, especially when the stress is its highest level. The reason for this variation in signal is due to the transitional stage, in which the proximity effect and dislocation of conductive paths and micro-cracks become functional. This transition is simultaneously overcome by the proximity effect as soon as the sample starts recovery and cracks are healed and dislocation is restored.

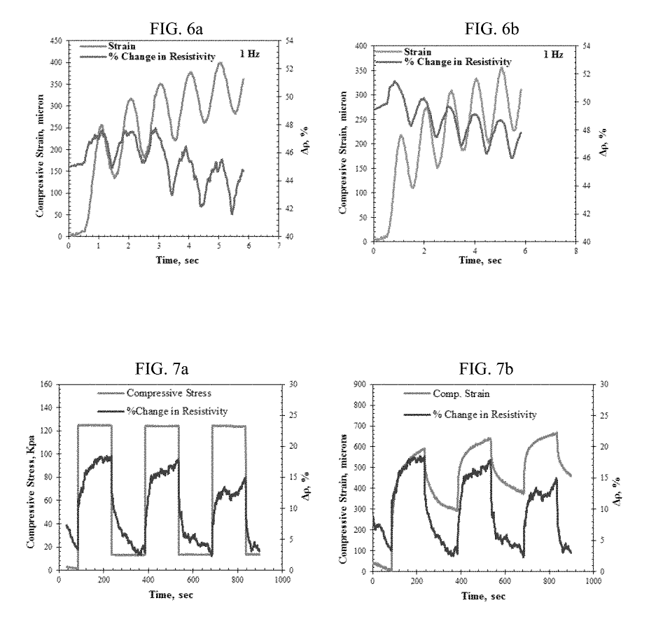

It can also be observed in FIG. 5 (b) that there is an overall decreasing trend in the percent change in resistivity (% Δρ) at 10 Hz for CNF-LHT modified mixtures. However, this trend was not significant for CNF-XTPS modified mixtures as shown in FIG. 5 (d). The possible reason is an overall increasing plastic strain in the CNF-LHT mixtures. In order to evaluate and explore this phenomenon percentage change in resistivity (% Δρ) was plotted at 1 Hz for both types of CNFs as shown in FIG. 6 (a, b).

FIG. 6 illustrates the results of both 5.3% CNF-LHT PAC 30 (FIG. 6 (a)) and 8.5% CNF-XTPS PAC30 (FIG. 6 (b)) modified mixtures at 1 Hz and 20° C. The percent change in resistivity (% Δρ) is plotted with compressive strain to understand the overall decreasing % Δρ trend for both 6 (a) and 6 (b). FIG. 6 (a, b) show that the mixtures respond well at 1 Hz; however, an overall decreasing trends in percent change in resistivity-which could not be observed at higher frequencies such as 25 Hz—was observed. This trend is unique as this overall decrease of percent change in resistivity will eventually affect the piezoresistive response of the mixtures at higher number of load cycles. HMA mixtures show viscous behavior at higher temperatures or lower frequencies. At 1 Hz, the behavior of the mixture is relatively viscous and it accumulates more plastic strain.

Although plastic strain enhances the proximity effect, which means that overall resistivity should decrease, the percent change in resistivity actually decreased. This indicates an increase in initial resistivity (ρₒ). At the onset, percent change in resistivity increased; however, after a third cycle it started to decrease. This could be due to excessive plastic strain accumulated in the sample. FIG. 6 (a, b) show that the permanent strain was accumulated at this stage. A somewhat similar trend was observed in the CNF XTPS modified HMA mixtures. However, the initial decreasing trend was not significant in that sample.

FIG. 7 (a) shows the effect of repeated creep square loading on percentage response of resistivity of the conductive HMA mixtures modified with CNF-LHT. It can be observed that percent change in resistivity (% Δρ) follows the compressive stress in resilient manner up to maximum stress level; however, percent change in resistivity continues to increase under sustained stress. This trend is because of viscoelastic behavior of HMA mixtures. The time dependent strain and strain recovery functionalizes proximity effect and resistivity follows this pattern. FIG. 7 (b) shows the comparison of percent change in resistivity and compressive strain under square loading. It is obvious from FIG. 7 (b) that change in resistivity is following the viscoelastic behavior of the conductive HMA. Overall plastic strain accumulation can also be observed in the FIG. 7 (b).

Additionally, FIG. 7 (a, b) show that the response behavior is resilience. Resistivity response follows strain's elastic response during loading, i.e.—the response of the sample is instantaneous when load is applied on the sample. This result demonstrates the effectiveness of the piezoresistive response of the HMA mixtures.

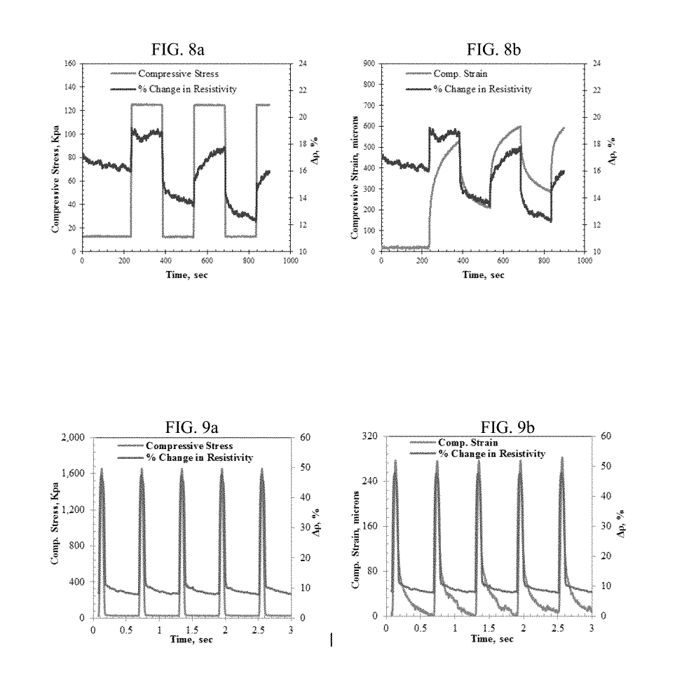

FIG. 8 (a, b) exhibits the piezoresistive response of 8.5% CNF-XTPS PAC30 conductive HMA mixture under repeated creep loading using square loading. The percent change in resistivity follows compressive stress similarly as was observed in CNF-LHT modified mixtures (see, FIG. 7 (a, b)). An overall decrease in percent change in resistivity can be observed due to creep effect.

FIG. 8 (b) depicts piezoresistive response with compressive strain in repeated creep loading. And FIG. 8 (a) depicts piezoresistive response with compressive stress creep loading. As shown in FIG. 8 (b), the non-viscoelastic response of change in resistivity of the conductive HMA, especially in first two cycles, is dictated by the rigidity of the material. The lower crack generation in the more rigid material keeps the proximity effect more effective than the crack and dislocation mechanisms. Thus, although a similar response is observed in this mixture as compare to CNF-LHT modified sample, it experiences a change in signal strength due to the rigidity of the material.

The percentage responses of CNF-LHT and CNF-XTPS modified HMA mixtures under repeated creep loading are 15% and 5%, respectively. The respective responses of CNF-LHT and CNF-XTPS under sinusoidal loading were 14% and 8%. This shows that CNF-LHT maintains its response strength even under different set of loading.

Because a 5.3% CNF-LHT modified HMA mixture exhibits strong and better piezoresistive response, it was used in this Example to evaluate the effects of temperature. A haversine wave form of 0.1 sec loading and 0.5 sec of rest period was used and the change in resistivity was monitored at temperatures of 200, 400 and 60° C.

FIG. 9 (a, b) depicts the piezoresistive response of CNF-LHT HMA mixtures under haversine loading at 20° C. FIG. 9 (a) depicts the compressive stress and FIG. 9 (b) depicts the compressive strain. The data in the figure reveals that the response is fairly clean and smooth. The HMA mixture responded to the loading in a precise manner. It can be observed that overall percent change in resistivity does not show an increasing or decreasing trend within the five loading cycles, likely due to the low rate of accumulation of plastic strain at room temperature. It was also observed that the voltage response lagged the strain response of HMA by 8 to 12 degrees.

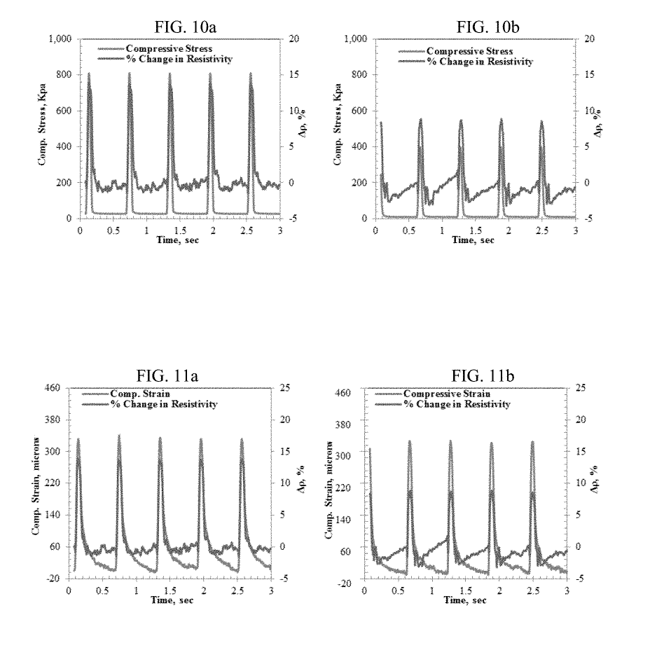

FIG. 10 (a, b) depicts the piezoresistive response in terms of percent change in resistivity with compressive stress at 400 and 60° C., respectively. FIG. 10 (a) depicts the compressive stress and FIG. 10 (b) depicts the compressive strain. FIG. 10 (a, b) demonstrates that percent change in resistivity exhibited a resilient decrease at the time when stress was applied, which was not normal behavior, as the response should increase on application of stress. This reaction could have been due to a disconnection between materials and the electrode or the rate of loading. This behavior was not found in sinusoidal loading as the loading wave was continuous and there was no rest period. However, the repeated creep loading exhibited similar trend, but it was negligible.

As show in the Figure, the response of the mixture at 40° C. is similar to the response at 20° C. and no abnormality in the response could be observed. However, response at 60° C. showed increasing trend during rest period, likely due to the relatively high temperature. HMA mixture is softer at 60° C. as compare to lower temperatures and when a load was suddenly removed, the material showed elastic recovery quickly and the response followed this sudden recovery. After elastic recovery the viscoelastic strain started to recover, thereby establishing new electric contacts through micro crack healing. Additionally, during the rest period the higher temperature induces the binder to continue to expand, which functionalizes the free binder to generate more contacts within the mix and keep increasing the response. The tensile strain recovery brings the CNF closer to each other and thermal expansion phenomenon of free conductive binder also provides connection for the flow of electricity. This composite effect results in decrease in resistivity during rest period of viscoelastic strain recovery.

It can also be observed in FIG. 10 (a, b) that percent change in resistivity of the sample at 40° C. is approximately 15% whereas at 60° C. the percent change in resistivity reduces to 9%. However, it should also be observed that the applied stress is 800 psi and 400 psi at 40° C. and 60° C., respectively. This demonstrates that piezoresistive response is mainly a function of elastic strain, therefore stress levels were altered to maintain the elastic strain level of 300±20 microns and the results are show in FIG. 11. It can be observed that the piezoresistive response decreased significantly due to temperature. High temperatures cause the material to become less rigid, thus for the same compressive strain the material experiences more lateral strain. The higher lateral strain disturbs the CNF network, resulting in a lower piezoresistive response.

FIG. 11 (a, b) shows the response of the material at 40° C. (11 (a)) and 60° C. (11 (b)) with compressive strain. It can be observed that at 40° C. (FIG. 11 (a)) strain behaves in viscoelastic manner at the rest period: however, resistivity remains constant likely due to the stiffness of the material.

In short, overall response of conductive-HMA at 40° C. (11 (a)) and 60° C. (11 (b)) is phenomenal: the response follows the loading cycles successively and without any abnormality or noise. This Example proves that CNF-LHT transformed HMA into an effective piezoresistive material, which responds at different frequencies, loading type and at different temperatures.

Phase angles between the strain and voltage responses were determined for both sine wave and haversine wave forms of loading and are reported in Table 2.

TABLE 2
Summary of phase angle (degree) between
strain and voltage responses

| | Temperature, | Frequency, Hz | | |
|---|---|---|---|---|
| Loading Type | ° C. | 25 | 10 | 5 |
| Sinusoidal Wave | 20 | 10.5 (1.5) | 14.1 (2.2) | 12.6 (2.7) |
| Haversine Wave | 20 | — | 11.7 (3.8) | — |
| | 40 | — | 29.4 (4.8) | — |
| | 60 | — | 41.2 (3.5) | — |

Because of the heterogeneous nature of HMA, some variation was observed in phase angle calculation. Occasionally the voltage signals exhibited uneven behavior at the peak load. Therefore, best fit curves were utilized to obtain the maximum strain and voltage responses, along with the times to reach to the maximum values for various types of loadings. The data in the table illustrates that the voltage response lagged the strain response of CNF HMA mixtures. Under sinusoidal wave form, some frequency dependency in phase angles existed. The average phase angle at 20° C. slightly increased at 25 to 10 Hz and then decreased at 5 Hz; however, the difference in phase angle values were not statistically significant at α value of 0.05.

The sufficient temperature dependency could also be observed for haversine loading wave form of 10 Hz as shown in Table 2. The phase angle increased with the increase in temperature. The coefficient of variation ranged from about 8 to 32 percent. The variation was high at low temperature as compared to high temperatures. Phase angle between strain and voltage responses were statistically significantly different at different temperatures at α value of 0.05.

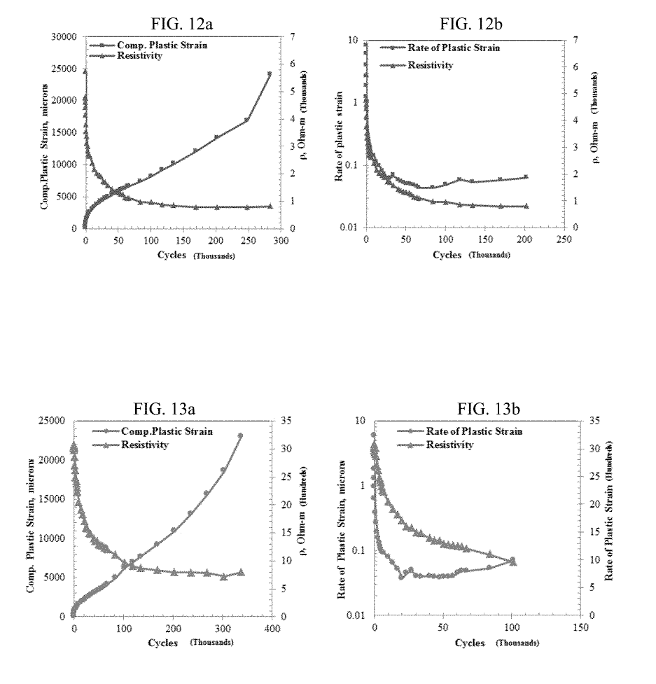

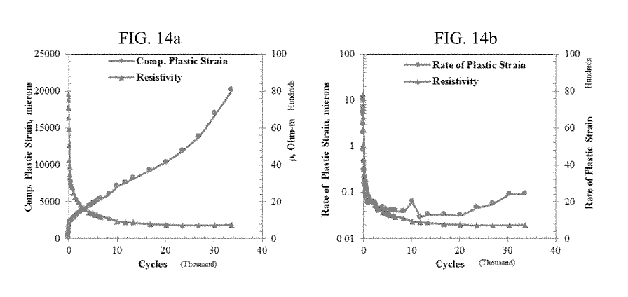

FIGS. 12 (a, b), 13 (a, b) and 14 (a, b) illustrate the resistivity (ρ) behavior of the conductive HMA modified with 5.3% CNF-LHT under repeated loading at 20° (12 (a, b)), 400 (13 (a, b)) and 60° C. (14 (a, b)), respectively. FIGS. 12 (a), 13(a), and 14 (a) depict the plastic strain and 12 (b), 13 (b), and 14 (b) depict the plastic strain rate. All samples exhibited a similar trend at all temperatures. Resistivity is inversely proportional to accumulated plastic strain. In initial cycles, the rate of strain is high which mitigates in the middle period and then increases again in the third period (in which the sample starts macro-cracking). Thus, resistivity decreases with an increase in plastic strain and then stabilizes for a relatively long period of time. As the number of cycles increase and sample experiences macro-crack generation, the resistivity also starts to increase. This demonstrates that the resistivity is not affected by temperature

For the purpose of understanding the Self-sensing Piezoresistive Hot Mix Asphalt, references are made in the text to exemplary embodiments of a Self-sensing Piezoresistive Hot Mix Asphalt, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the Self-sensing Piezoresistive Hot Mix Asphalt may be practiced without one or more of the specific features or advantages of a particular embodiment. In other instances, additional features and advantages may be recognized in certain embodiments that may not be present in all embodiments.

1. A self-sensing piezoresistive hot mix asphalt mixture comprising:
a. an asphalt binder dosed with a conductive filler; and
b. an aggregate material dispersed within said asphalt binder, wherein said aggregate further comprises said conductive filler.

2. The self-sensing piezoresistive hot mix asphalt of claim 1 wherein said conductive filler is a nano material.

3. The self-sensing piezoresistive mix asphalt of claim 2 wherein said nano material is carbon nanofibers.

4. The self-sensing piezoresistive asphalt of claim 1 wherein said asphalt binder is a viscosity graded asphalt.

5. The self-sensing piezoresistive asphalt of claim 4 wherein said asphalt binder is AC5.

6. The self-sensing piezoresistive hot mix asphalt of claim 1 wherein said asphalt binder is PAC30.

7. The self-sensing piezoresistive hot mix asphalt of claim 1 wherein said aggregate is angular limestone.

8. The self-sensing piezoresistive hot mix asphalt of claim 3 wherein aid nano-reinforced materials is selected from the group consisting of Vapor-grown CNF PR-24XT-XTPS and CNF PR-24XT-LHT.

9. A method for creating a self-sensing piezoresistive hot mix asphalt comprising the steps of:
a. homogenously dispersing a set amount of a conductive filler in cut back solvent by sonication and high shear mixing, creating a conductive filler-solvent mixture;
b. combining said conductive filler-solvent mixture with an asphalt binder at a set mixing temperature, creating an asphalt binder-filler mixture;
c. homogenously dispersing a second set amount of conductive filler in to a second cut back solvent by sonication and high shear mixing, creating a second conductive filler-solvent mixture;
d. evaporating said second conductive filler-solvent mixture at room temperature;
e. oven heating said second conductive filler-solvent mixture, creating oven-dried conductive filler;
f. combining said asphalt binder-filler mixture, said oven-drive conductive filler, and an aggregate to form a hot mix asphalt mixture;
g. heating said hot mix asphalt mixture; and
h. thoroughly mixing said hot mix asphalt mixture.

10. The method of claim 8 wherein said set amount of conductive filler is between 0.5 and 2.5 percent by weight of binder.

11. The method of claim 9 wherein said mixing temperature is between 100 and 180 degrees Celsius.

12. The method of claim 9 wherein said thoroughly mixing step is performed with a bench mixer.

13. The method of claim 9 wherein said conductive filler is a nano material.

14. The method of claim 13 wherein said nano material is carbon nanofibers.

15. A method for creating a self-sensing piezoresistive hot mix asphalt comprising the steps of:
a. mixing a set amount of dried conductive filler into an asphalt binder, creating an asphalt binder-filler mixture;
b. mixing a set amount of dried conductive filler into an aggregate, creating an aggregate-filler mixture;
c. combining said asphalt binder-filler mixture and said aggregate-filler mixture to create a hot mix asphalt mixture;
d. heating said hot mix asphalt mixture at a set temperature; and
e. thoroughly mixing said hot mix asphalt mixture.

16. The method of claim 15 wherein said set amount of dried conductive filler is between 0.1 and 0.5 percent by weight of said asphalt binder.

17. The method of claim 15 wherein said set temperature is between 100 and 150 degrees Celsius.

18. The method of claim 15 wherein said thoroughly mixing step is performed using a bench mixture.

19. The method of claim 15 wherein said conductive filler is a nano material.

20. The method of claim 19 wherein said nano material is carbon nano fibers.
